(19) United States
(12) Patent Application Publication
(10) Pub. No.: US 2026/0261180 A1
(43) Pub. Date: Sep. 3, 2026

(54) ELECTRIC COMPRESSOR

(71) Applicant: SANDEN CORPORATION, Isesaki-shi, Gunma (JP)

(72) Inventors: Toshimasa SHIMA, Isesaki-shi, Gunma (JP); Atsuo TESHIMA, Isesaki-shi, Gunma (JP); Kazuya MATSUZAKI, Isesaki-shi, Gunma (JP)

(21) Appl. No.: 19/491,218

(22) PCT Filed: Aug. 7, 2024
(86) PCT No.: PCT/JP2024/028199

§ 371 Date: Dec. 8, 2025

(30) Foreign Application Priority Data
Sep. 1, 2023 (JP) 2023-142176

(51) Int. Cl. H02K 5/22; H02K 11/33

(52) U.S. Cl. CPC H02K 5/225; H02K 11/33; H02K 2211/03

(57) ABSTRACT

When a circuit board of an inverter is attached, even if a tip of a connection terminal hits the circuit board, it is difficult to bend the tip. An electric compressor includes an electric motor, a rotating shaft, a compression mechanism, an inverter, a housing having a first accommodation chamber that accommodates the electric motor, the rotating shaft, and the compression mechanism, and a second accommodation chamber that accommodates the inverter, a hermetic terminal provided in a partition wall that partitions the first accommodation chamber and the second accommodation chamber, and a connection terminal that connects the hermetic terminal and the inverter. A terminal receiving member is disposed between the hermetic terminal and the connection terminal, and provides plural insertion holes through which each terminal portion of the hermetic terminal can be inserted and a terminal receiving surface for receiving the connection terminal.

### TECHNICAL FIELD

The present invention relates to an electric compressor that compresses a refrigerant.

### BACKGROUND ART

As disclosed in JP 2015-115969 A (Patent Literature 1), an electric compressor that compresses a refrigerant includes an electric motor such as a three-phase brushless motor, a compression mechanism driven by the electric motor, and an inverter that drives and controls the electric motor. Then, the inverter sequentially supplies the DC current supplied from the DC power supply to each phase coil of the electric motor while converting the DC current into the AC current, thereby rotating the electric motor at a desired rotation speed. In such an electric compressor, each phase coil of the electric motor is electrically connected to the circuit board of the inverter via a hermetic terminal and a connection terminal connected thereto. Here, the tip of the connection terminal has a pin shape, and passes through the through hole of the circuit board and is soldered.

### CITATION LIST

### Patent Literature

Patent Literature 1: JP-A-2015-115969

### SUMMARY OF INVENTION

### Problems to be Solved by Invention

In a step of assembling an electric compressor, a connection terminal is attached to a hermetic terminal, a circuit board is disposed from above the connection terminal, and a tip of the connection terminal protruding from the through hole of the circuit board is soldered. At this time, in a case where the positioning of the through hole of the circuit board with respect to the tip of the connection terminal is insufficient, the tip of the connection terminal may hit the circuit board and bend. In a case where the connection terminal is bent, the tip of the connection terminal cannot protrude from the through hole of the circuit board and cannot be soldered.

Therefore, an object of the present invention is to provide an electric compressor in which, in a case where a circuit board of an inverter for driving an electric motor is attached, it is difficult to bend even if a tip of a connection terminal hits the circuit board.

### Solution to Problems

An electric compressor includes an electric motor, a rotating shaft rotated by the electric motor, a compression mechanism driven by the rotating shaft, an inverter that drives the electric motor, and a housing including a first accommodation chamber that accommodates the electric motor, the rotating shaft, and the compression mechanism, and a second accommodation chamber that accommodates the inverter.

The electric compressor further includes a hermetic terminal provided in a partition wall partitioning the first accommodation chamber and the second accommodation chamber of the housing and having a plurality of terminal portions electrically connected to the electric motor, and a connection terminal electrically connecting the terminal portion of the hermetic terminal and the inverter. A terminal receiving member is disposed between the hermetic terminal and the connection terminal, a terminal receiving member having a plurality of insertion holes through which each terminal portion of the hermetic terminal can be inserted and a terminal receiving surface for receiving the connection terminal.

### Effects of Invention

According to the present invention, in the electric compressor, in a case where the circuit board of the inverter that drives the electric motor is attached, even if the tip of the connection terminal attached to the hermetic terminal hits the circuit board, it is possible to make it difficult to bend.

### BRIEF DESCRIPTION OF DRAWINGS

FIG. 1 is a longitudinal sectional view illustrating an example of an electric compressor.

FIG. 2 is a perspective view illustrating an example of an attachment structure of an inverter circuit unit to a housing.

FIG. 3 is an enlarged perspective view of a portion A in FIG. 2.

FIG. 4 is a perspective view illustrating an example of a connection terminal.

FIG. 5 is a perspective view illustrating an example of a terminal receiving member as viewed from above.

FIG. 6 is a perspective view illustrating an example of a terminal receiving member as viewed from below.

FIG. 7 is an enlarged perspective view illustrating an example of an opening formed in the inverter circuit board.

FIG. 8 is an explanatory view of a method of assembling a hermetic terminal.

FIG. 9 is an explanatory view of a method of assembling a terminal receiving member.

FIG. 10 is an explanatory view of a method of fixing the terminal receiving member.

FIG. 11 is an explanatory view of a method of assembling connection terminals.

FIG. 12 is an explanatory view of a method of assembling the inverter circuit board.

FIG. 13 is an explanatory view of a structure for receiving a connection terminal by a terminal receiving member.

### DESCRIPTION OF EMBODIMENTS

Hereinafter, embodiments for carrying out the present invention will be described in detail with reference to the accompanying drawings. It should be noted that the terms “first”, “second”, and the like used in the following description are merely used to distinguish between similar elements, and do not limit the elements to which they are attached. Furthermore, the embodiment described below is merely an example, and should not be construed as being limited to the configuration.

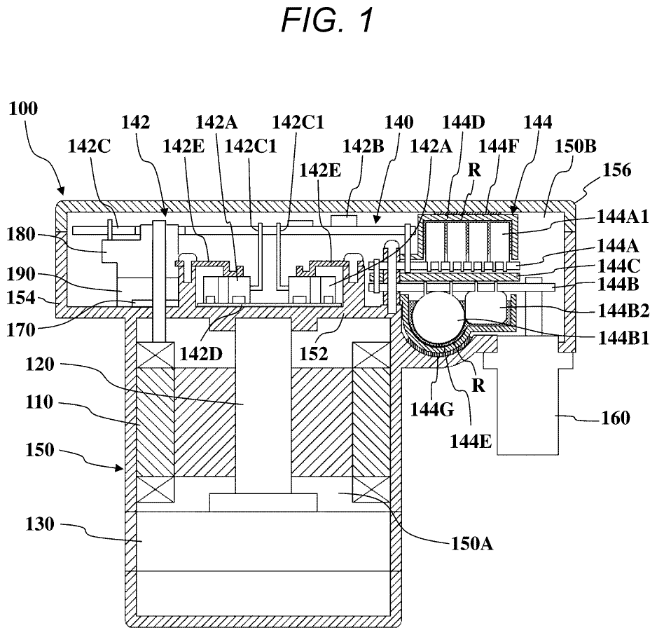

FIG. 1 illustrates an example of an inverter-integrated electric compressor 100 to which the present invention can be applied. The electric compressor 100 is incorporated in, for example, a refrigerant circuit (not shown) of an air conditioner mounted on a vehicle, and is configured to compress and discharge a refrigerant.

The electric compressor 100 includes an electric motor 110, a rotating shaft 120 driven by the electric motor 110, a compression mechanism 130 driven by the rotating shaft 120, an inverter 140 that drives the electric motor 110, and a housing 150 that accommodates the electric motor 110, the rotating shaft 120, the compression mechanism 130, and the inverter 140. Here, an internal space of the housing 150 is partitioned by a partition wall 152 into a first accommodation chamber 150A that accommodates the electric motor 110, the rotating shaft 120, and the compression mechanism 130 and a second accommodation chamber 150B that accommodates the inverter 140.

The electric motor 110 is, for example, a three-phase brushless motor, and is configured such that an alternating current is sequentially supplied to a U-phase coil, a V-phase coil, and a W-phase coil wound around a tooth portion of a stator to generate a magnetic field, and a rotor including a permanent magnet disposed inside the magnetic field rotates. The rotating shaft 120 is rotatably supported by the housing 150 by a bearing (not illustrated), and an intermediate portion thereof is press-fitted into the center of the rotor. Therefore, while the electric motor 110 rotates, the rotating shaft 120 rotates integrally with the rotor. The compression mechanism 130 is, for example, a known compression mechanism such as a scroll compression mechanism or a rotary compression mechanism, and is driven by the rotating shaft 120. Note that the scroll compression mechanism, the rotary compression mechanism, and the like are compression mechanisms well known to those skilled in the art, and thus detailed description thereof will be omitted.

The inverter 140 includes an inverter circuit unit 142 that converts a direct current supplied from a direct current power supply into an alternating current and supplies the alternating current to the electric motor 110, and a filter circuit unit 144 that reduces electromagnetic noise. Note that a direct current is supplied to the inverter circuit unit 142 from, for example, an in-vehicle battery exemplified as a direct current power supply via an HV connector 160 attached to a predetermined portion of the housing 150.

The inverter circuit unit 142 includes six power switching elements 142A, a control circuit 142B that controls the six power switching elements 142A, and an inverter circuit board 142C on which the control circuit 142B is mounted. The six power switching elements 142A are placed on an upper surface of a sheet-like first heat dissipation member 142D disposed on a wall surface of the partition wall 152 of the housing 150 facing the second accommodation chamber 150B. Each of the six power switching elements 142A is fixed in a state of being pressed against the first heat dissipation member 142D by an arm member 142E. Each terminal of the six power switching elements 142A is electrically connected to the inverter circuit board 142C by passing through through holes 142C1 formed in the inverter circuit board 142C and being soldered to the wiring pattern.

The inverter circuit board 142C of the inverter circuit unit 142 is electrically connected to each phase coil wound around the stator of the electric motor 110 via a hermetic terminal 170 and a connection terminal 180 provided at a predetermined position of the partition wall 152 of the housing 150. Note that details of the hermetic terminal 170, the connection terminal 180, and a connection structure between these terminals and the inverter circuit board 142C will be described later.

The filter circuit unit 144 includes a first filter circuit board 144A and a second filter circuit board 144B.

As an example of a first filter component for electromagnetic noise countermeasures, at least one electrolytic capacitor 144A1 is mounted on one surface (surface facing upward in FIG. 1) of the first filter circuit board 144A in an upright state. A plurality of electronic components (not illustrated) smaller than the electrolytic capacitor 144A1 is also mounted on the first filter circuit board 144A. At least a part of the small electronic component is mounted on the other surface (a surface facing downward in FIG. 1) of the first filter circuit board 144A, which is a portion avoiding the arrangement position of the electrolytic capacitor 144A1.

As an example of a second filter component for electromagnetic noise countermeasures, a normal mode choke coil 144B1, a common mode choke coil 144B2, an X capacitor, and a Y capacitor (not shown) are mounted on one surface (surface facing downward in FIG. 1) of the second filter circuit board 144B. A plurality of electronic components (not illustrated) smaller than the normal mode choke coil 144B1, the common mode choke coil 144B2, the X capacitor, and the Y capacitor is also mounted on the second filter circuit board 144B. At least a part of the small electronic component is mounted on the other surface (surface facing upward in FIG. 1) of the second filter circuit board 144B, which is a portion avoiding the arrangement positions of the normal mode choke coil 144B1, the common mode choke coil 144B2, the X capacitor, and the Y capacitor.

The first filter circuit board 144A and the second filter circuit board 144B are integrated with a plate-like resin member 144C interposed therebetween in an electrically connected state. A first case member 144D made of a hard resin or the like is attached to one surface of the first filter circuit board 144A so as to accommodate the plurality of electrolytic capacitors 144A1. A second case member 144E made of a hard resin or the like is attached to one surface of the second filter circuit board 144B so as to accommodate the normal mode choke coil 144B1, the common mode choke coil 144B2, the X capacitor, and the Y capacitor. The first case member 144D and the second case member 144E are filled with a resin R having heat resistance to improve the protection and heat dissipation of the plurality of electrolytic capacitors 144A1, the normal mode choke coil 144B1, the common mode choke coil 144B2, and the like disposed therein. In this manner, the filter circuit unit 144 is modularized.

As described above, the internal space of the housing 150 is partitioned by the partition wall 152 into the substantially columnar first accommodation chamber 150A that accommodates the electric motor 110, the rotating shaft 120, and the compression mechanism 130, and the substantially rectangular parallelepiped second accommodation chamber 150B that accommodates the inverter 140. Here, it should be noted that the cylindrical shape and the rectangular parallelepiped shape are not limited to a strict cylindrical shape and a rectangular parallelepiped shape, and include shapes that can be recognized as a cylindrical shape and a rectangular parallelepiped shape at a glance (hereinafter, the same applies to the shape). The second accommodation chamber 150B is partitioned by the partition wall 152, a peripheral wall 154 rising from a peripheral edge of the partition wall 152 toward the inverter 140, and a lid 156 detachably joined to an opening of the peripheral wall 154.

In the first accommodation chamber 150A, the compression mechanism 130 and the electric motor 110 in which the rotating shaft 120 is integrated are accommodated in this order from a distal portion to a proximal portion with respect to the second accommodation chamber 150B. In the second accommodation chamber 150B, the inverter circuit unit 142 is accommodated in a portion overlapping with the first accommodation chamber 150A as viewed from an axial direction of the rotating shaft 120, and the modularized filter circuit unit 144 is accommodated in a portion separated from the former portion.

Although not clearly illustrated in FIG. 1, the inverter circuit unit 142 and the filter circuit unit 144 are electrically connected. At this time, a sheet-like second heat dissipation member 144F and a sheet-like third heat dissipation member 144G are disposed between the filter circuit portion 144 and the inner surface of the housing 150 that defines the second accommodation chamber 150B. For this reason, the amount of heat transmitted from the filter circuit portion 144 to the housing 150 increases, whereby the heat dissipation of the filter circuit portion 144 is improved.

Here, details of the hermetic terminal 170, the connection terminal 180, and the connection structure between these terminals and the inverter circuit board 142C will be described.

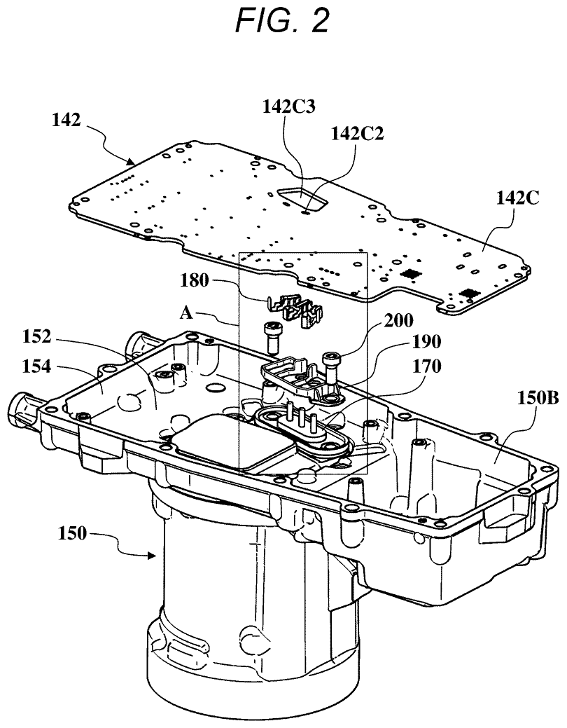

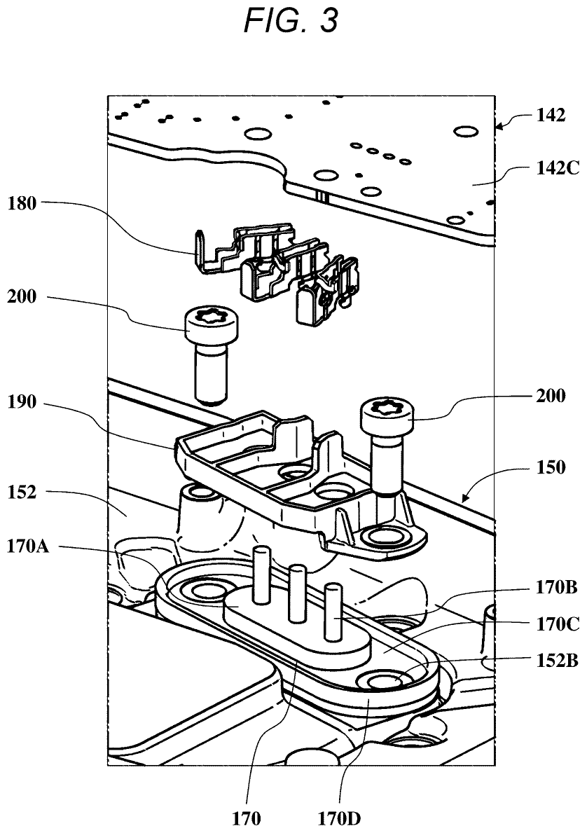

As illustrated in FIGS. 2 and 3, the hermetic terminal 170 is provided at a predetermined position of the partition wall 152 of the housing 150 facing the second accommodation chamber 150B. The hermetic terminal 170 includes a first plate portion 170A that ensures an airtight state between the first accommodation chamber 150A and the second accommodation chamber 150B, three terminal portions 170B each having a pin shape and penetrating the plate surface of the first plate portion 170A in the vertical direction, and a second plate portion 170C that receives the first plate portion 170A. The first plate portion 170A is made of silicon rubber having an insulating property, and is formed in, for example, an oval shape in plan view. The three terminal portions 170B are made of a metal material having conductivity, and are arranged on a straight line in a state of being separated from each other with respect to the first plate portion 170A. The second plate portion 170C is made of a cold-rolled steel plate securing an insulation distance from the three terminal portions 170B, and is formed in, for example, an oval shape larger than the first plate portion 170A in plan view. Here, a pedestal portion (not illustrated) that receives the second plate portion 170C of the hermetic terminal 170 is formed on a wall surface of the partition wall portion 152 facing the second accommodation chamber 150B. A peripheral edge 170D rising perpendicularly from the plate surface of the second plate portion 170C is formed on the peripheral edge of the second plate portion 170C. Here, the first plate portion 170A and the second plate portion 170C are examples of the plate portion. In the present embodiment, as illustrated in FIG. 1, the terminal portion 170B of the hermetic terminal 170 extends to a position beyond the inverter circuit board 142C of the inverter circuit portion 142 accommodated in the second accommodation chamber 150B, but the present embodiment is not limited thereto.

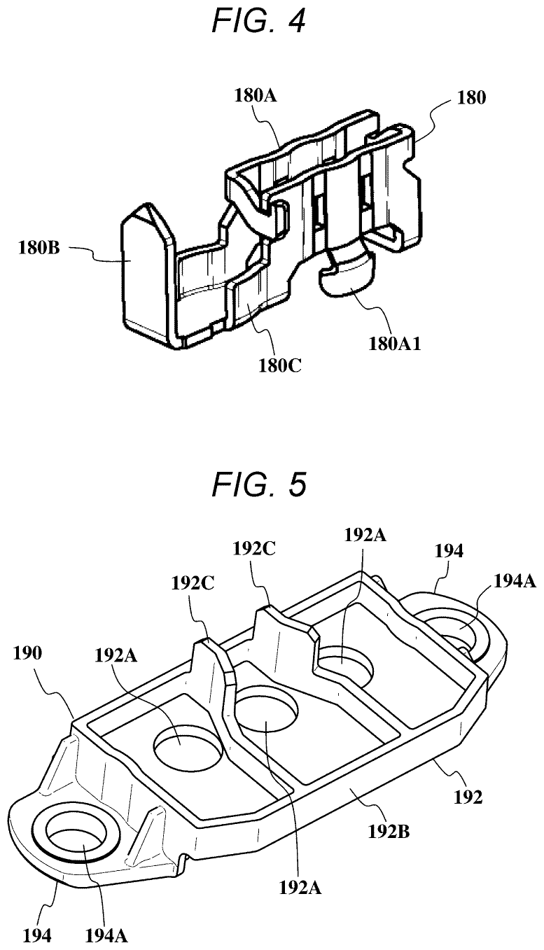

The connection terminal 180 is a terminal that electrically connects the terminal portion 170B of the hermetic terminal 170 and the inverter circuit board 142C of the inverter circuit portion 142, and is formed of, for example, an elastically deformable thin plate-shaped metal plate. As illustrated in FIG. 4, the connection terminal 180 includes a press-fitting portion 180A press-fitted into the terminal portion 170B of the hermetic terminal 170, and a protrusion 180B that penetrates a through hole 142C2 (see FIG. 2) formed in an inverter circuit board 142C and is soldered.

The press-fitting portion 180A is formed of a rectangular tube member having a rectangular cross section in which two surfaces in a direction in which the terminal portion 170B of the hermetic terminal 170 extends are opened, and a pair of guide portions 180A1 for guiding the tip of the terminal portion 170B is integrally formed at an intermediate portion of the two surfaces sandwiching the terminal portion 170B. Here, the tip of the guide portion 180A1 (the end portion located below in FIG. 4) is formed in a shape following the tip of the terminal portion 170B, as a result of which the tip of the terminal portion 170B can be guided to the press-fitting portion 180A while not being easily detached. Therefore, the press-fitting portion 180A is pushed toward the hermetic terminal 170 in a state where the guide portion 180A1 is aligned with the tip of the terminal portion 170B of the hermetic terminal 170, in such a manner that alignment of the press-fitting portion 180A with respect to the terminal portion 170B can be simultaneously performed. Both end portions of the end portion of the press-fitting portion 180A positioned on the hermetic terminal 170 side are connected by a rectangular metal plate parallel to the plate surface of a terminal receiving member 190 for the purpose of improving adhesion to the terminal receiving member 190 described later in detail.

The protrusion 180B is formed of a flat plate-shaped plate member having an L shape in a side view, which extends outward from an end portion of the press-fitting portion 180A positioned on the hermetic terminal 170 side by a predetermined dimension, and then vertically bends and extends toward the inverter circuit board 142C. Since the protrusion 180B is formed of a plate member having a flat plate shape, a cost can be reduced as compared with a pin shape. Here, the tip of the protrusion 180B is formed in a tapered shape in which the width gradually decreases toward the tip. The portion of the protrusion 180B extending outward from the end of the press-fitting portion 180A is disposed flush with the end of the press-fitting portion 180A located on the hermetic terminal 170 side. In order to secure the strength of the portion of the protrusion 180B extending outward from the end of the press-fitting portion 180A, as illustrated in FIG. 4, a rectangular reinforcing portion 180C joined perpendicularly to the portion may be integrated.

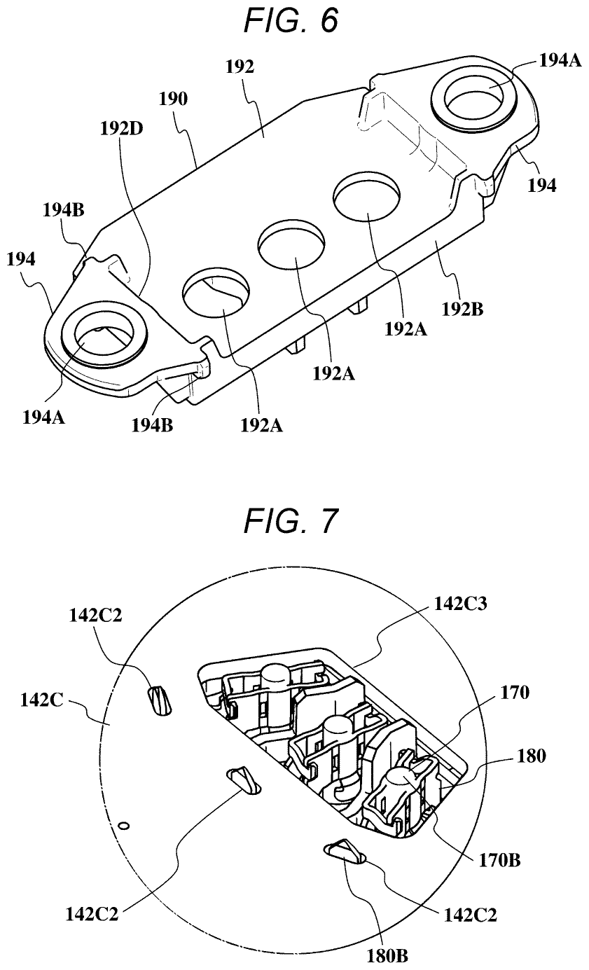

The terminal receiving member 190 made of, for example, a hard resin is disposed between the hermetic terminal 170 and the connection terminal 180. As illustrated in FIGS. 5 and 6, the terminal receiving member 190 includes a main body 192 having a rectangular shape in plan view, and a pair of semicircular attachment portions 194 integrally joined to both end portions of the main body 192 in the longitudinal direction.

Three insertion holes 192A through which the three terminal portions 170B of the hermetic terminal 170 can be inserted are formed in the main body 192. One surface of the main body 192 located on the connection terminal 180 side functions as a terminal receiving surface that receives the connection terminal 180. Therefore, one surface of the main body 192 is formed in a flat shape.

Further, on one surface of the main body 192, an annular outer edge rib 192B extending from the outer edge toward the connection terminal 180, and an insulating rib 192C for securing an insulating distance of each terminal portion 170B of the hermetic terminal 170 inserted through the insertion hole 192A are integrally formed. Here, for example, when the connection terminal 180 press-fitted into the terminal portion 170B of the hermetic terminal 170 by an external force attempts to rotate, a part of the connection terminal 180 comes into contact with the outer edge rib 192B and can suppress the rotation. The insulating rib 192C connects the outer edge ribs 192B located on both sides in the longitudinal direction of the main body 192 at two locations so as to divide the three insertion holes 192A formed in the main body 192. The height of at least a part of the insulating rib 192C with respect to the main body 192 is higher than the height of the outer edge rib 192B in order to reliably secure the insulation distance of each terminal portion 170B of the hermetic terminal 170. In other words, it can be said that the height of the outer edge rib 192B is lower than that of the insulating rib 192C. Therefore, by integrally providing the insulating rib 192C on the terminal receiving member 190, it is possible to cope with a high voltage and to improve safety.

In order to fix the terminal receiving member 190 to the partition wall portion 152 of the housing 150 with the hermetic terminal 170 interposed, for example, a bolt insertion hole 194A through which a shaft portion of a bolt 200, which is an example of a fastening member, can be inserted is formed in the attachment portion 194. Therefore, as illustrated in FIG. 3, a bolt fastening hole 152B to which the bolt 200 for fixing the terminal receiving member 190 to the partition wall 152 is fastened is formed in the vicinity of the pedestal portion 152A formed on the wall surface of the partition wall 152 facing the second accommodation chamber 150B.

On the other surface of the main body 192 located on the hermetic terminal 170 side, as shown in FIG. 6, a recess 192D capable of accommodating the first plate portion 170A of the hermetic terminal 170 is formed. Here, the depth of the recess 192D of the main body 192 can be, for example, the same as or slightly larger than the thickness of the first plate portion 170A of the hermetic terminal 170. In this way, when the terminal receiving member 190 is fixed to the partition wall portion 152 of the housing 150 by the bolt 200, the hermetic terminal 170 can be fastened together by the bolt 200 while avoiding interference with the first plate portion 170A made of silicone rubber, so that cost reduction regarding assembly work can be achieved. Further, on both sides of the base end portion of the attachment portion 194, convex portions 194B that can be fitted to the inner wall of the peripheral edge portion 170D of the hermetic terminal 170 are formed.

Such a terminal receiving member 190 receives the end portions of the press-fitting portion 180A and the protrusion 180B of the connection terminal 180 by one surface thereof, and even if an external force acts on the tip of the protrusion 180B, it is possible to make it difficult to bend the protrusion 180B.

In a state where the hermetic terminal 170, the connection terminal 180, and the terminal receiving member 190 are assembled to the housing 150, the tip of the terminal portion 170B of the hermetic terminal 170 and the press-fitting portion 180A of the connection terminal 180 interfere with the inverter circuit board 142C of the inverter circuit unit 142. Therefore, in the present embodiment, as illustrated in FIGS. 2 and 7, an opening 142C3 that avoids interference with each terminal portion 170B of the hermetic terminal 170 and the press-fitting portion 180A of the connection terminal 180 is formed at a predetermined position of the inverter circuit board 142C. In a case where there is no interference between the hermetic terminal 170 and the connection terminal 180, and the inverter circuit board 142C, it is needless to say that it is not necessary to form the opening 142C3 in the inverter circuit board 142C.

Here, a procedure of assembling the hermetic terminal 170, the connection terminal 180, and the terminal receiving member 190 to the housing 150, and a procedure of connecting the inverter circuit board 142C of the inverter circuit unit 142 to the connection terminal 180 will be described.

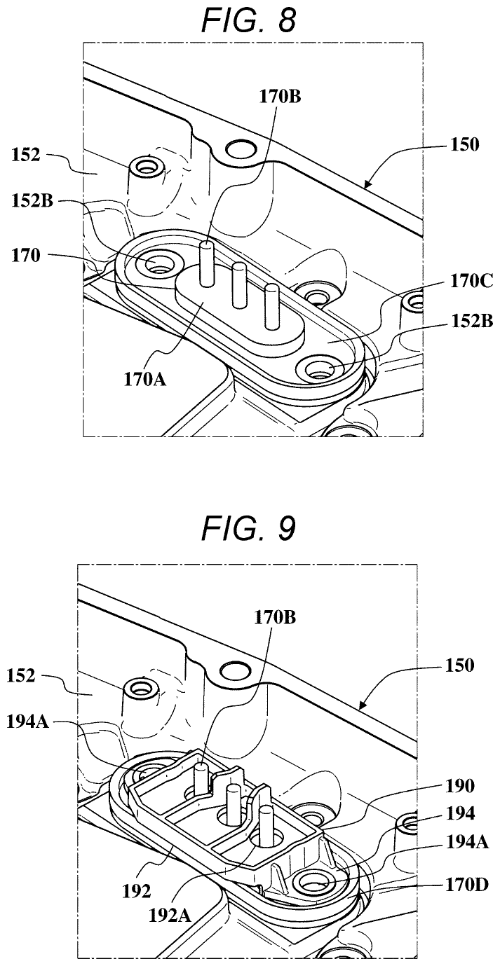

First, as shown in FIG. 8, the operator inserts the terminal portion 170B of the hermetic terminal 170 into an attachment hole (not shown) formed at a predetermined position of the partition wall 152 of the housing 150 for the hermetic terminal 170, and places the second plate portion 170C of the hermetic terminal 170 on the upper surface of the pedestal portion formed in the partition wall 152. Next, as illustrated in FIG. 9, the operator places the terminal receiving member 190 on the upper surface of the second plate portion 170C of the hermetic terminal 170 while inserting the terminal portion 170B of the hermetic terminal 170 into the insertion hole 192A of the terminal receiving member 190. At this time, since the first plate portion 170A of the hermetic terminal 170 is accommodated in the recess 192D formed on the other surface of the terminal receiving member 190, interference with the first plate portion 170A made of silicone rubber can be avoided. In addition, since the tip of the attachment portion 194 of the terminal receiving member 190 and the two protruding portions 194B are fitted to the inner wall of the peripheral portion 170D of the hermetic terminal 170, the terminal receiving member 190 is positioned with respect to the hermetic terminal 170.

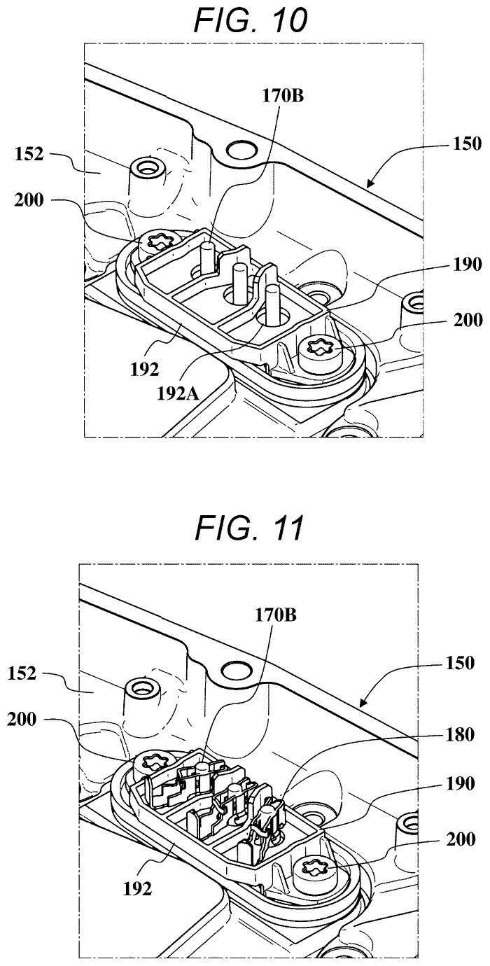

As illustrated in FIG. 10, the operator inserts the shaft portion of the bolt 200 into the bolt insertion hole 194A of the terminal receiving member 190, and screws and fastens the bolt 200 to the bolt fastening hole 152B formed in the partition wall 152 of the housing 150. At this time, since the terminal receiving member 190 is positioned with respect to the housing 150 and the terminal receiving member 190 is already positioned with respect to the hermetic terminal 170, the hermetic terminal 170 is also positioned with respect to the housing 150 at the same time.

Next, as illustrated in FIG. 11, the operator press-fits the press-fitting portion 180A of the connection terminal 180 from above each terminal portion 170B of the hermetic terminal 170 protruding from the upper surface of the terminal receiving member 190. At this time, since the guide portion 180A1 is formed in the press-fitting portion 180A of the connection terminal 180, the operator may align the tip of the guide portion 180A1 with respect to the tip of the terminal portion 170B of the hermetic terminal 170, and press the connection terminal 180 toward the terminal receiving member 190. As a result, the connection terminal 180 can be easily press-fitted into the hermetic terminal 170.

In a state where the connection terminal 180 is press-fitted into the terminal portion 170B of the hermetic terminal 170, when a certain degree of external force acts on the connection terminal 180, the connection terminal 180 can rotate around the central axis of the terminal portion 170B. Further, as shown in FIG. 11, if the protrusions 180B of the respective connection terminals 180 can be arranged so as to spread in a fan shape with respect to the respective terminal portions 170B of the hermetic terminal 170, an insulation distance of the respective protrusions 180B can be gained. Here, the respective connection terminals 180 press-fitted into the respective terminal portions 170B of the hermetic terminal 170 may have the same shape, or the lengths of the protrusions 180B with respect to the press-fitting portion 180A may be different.

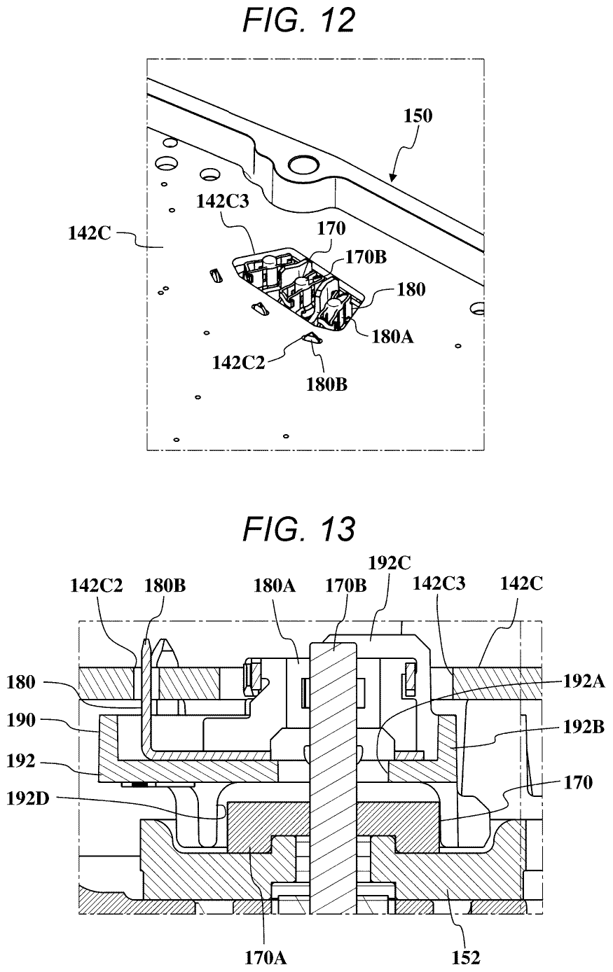

Then, as illustrated in FIG. 12, the operator presses the inverter circuit board 142C toward the partition wall 152 of the housing 150 while aligning the through hole 142C2 of the inverter circuit board 142C with the tip of the protrusion 180B of the connection terminal 180 press-fitted into the hermetic terminal 170. At this time, as illustrated in FIG. 13, since the lower surface of the connection terminal 180 is entirely supported by the upper surface of the terminal receiving member 190, even if the alignment of the inverter circuit board 142C with respect to the protrusion 180B of the connection terminal 180 is insufficient, the protrusion 180B of the connection terminal 180 can be suppressed from being bent.

In addition, since the tip of the protrusion 180B of the connection terminal 180 is formed in a tapered shape, even if the tip of the protrusion 180B of the connection terminal 180 is slightly shifted with respect to the through hole 142C2 of the inverter circuit board 142C, the connection terminal 180 does not rotate around the terminal portion 170B of the hermetic terminal 170, and a defect does not occur. Thereafter, the operator solder-joins the tip of the protrusion 180B of the connection terminal 180 protruding from the through hole 142C2 of the inverter circuit board 142C to establish electrical connection between the electric motor 110 and the inverter circuit board 142C.

In this way, if the hermetic terminal 170, the connection terminal 180, and the terminal receiving member 190 are assembled to the housing 150, for example, it is not necessary to make them a subassembly in advance in another process, and cost can be reduced.

Next, the operation of the electric compressor 100 will be described.

The direct current is sequentially supplied to each phase coil of the electric motor 110 while being converted into the alternating current in the inverter 140, and then the electric motor 110 is operated to rotate the rotating shaft 120. The compression mechanism 130 is operated by the rotation of the rotating shaft 120, the pressure of the first accommodation chamber 150A in which the compression mechanism 130 is disposed becomes a negative pressure, and the low-pressure refrigerant is sucked into the first accommodation chamber 150A from a refrigerant suction hole (not illustrated) formed at a predetermined position of the housing 150. The low-pressure refrigerant sucked into the first accommodation chamber 150A is introduced into the compression mechanism 130 while passing around the electric motor 110 to cool the electric motor 110. The low-pressure refrigerant introduced into the compression mechanism 130 is compressed by a change in volume of the compression chamber, and then discharged from a refrigerant discharge hole (not illustrated) formed in a predetermined portion of the housing 150 to, for example, a high-pressure side of a refrigerant circuit of an air conditioner mounted on a vehicle.

Since the compression of the refrigerant by the electric compressor 100 is well known to those skilled in the art, further detailed description will be omitted.

It should be noted that those skilled in the art will easily understand that new embodiments can be created by omitting some of the technical ideas of the various embodiments, appropriately combining some of the technical ideas, or replacing some of the technical ideas with well-known techniques.

As an example, the tip of the protrusion 180B of the connection terminal 180 is not limited to the flat plate shape, and may have a pin shape similar to that of the related art. The inverter circuit unit 142 accommodated in the second accommodation chamber 150B of the housing 150 is not limited to the single inverter circuit board 142C, and may be a multilayer inverter circuit board 142C.

### LIST OF REFERENCE SIGNS

100 Electric compressor
110 Electric motor
120 Rotating shaft
130 Compression mechanism
140 Inverter
142C Inverter circuit board
142C2 Through hole
142C3 Opening
150 Housing
150A First accommodation chamber
150B Second accommodation chamber
152 Partition wall
170 Hermetic terminal
170A First plate portion (plate portion)
170B Terminal portion
170C Second plate portion (plate portion)
180 Connection terminal
180A press-fitting portion
180B Protrusion
190 Terminal receiving member
192A Insertion hole
192B Outer edge rib
192C Insulating rib
192D Recess

1. An electric compressor comprising:
an electric motor;
a rotating shaft rotated by the electric motor;
a compression mechanism driven by the rotating shaft;
an inverter that drives the electric motor;
a housing including a first accommodation chamber that accommodates the electric motor, the rotating shaft, and the compression mechanism, and a second accommodation chamber that accommodates the inverter;
a hermetic terminal provided in a partition wall partitioning the first accommodation chamber and the second accommodation chamber of the housing and including a plurality of terminal portions electrically connected to the electric motor;
a connection terminal that electrically connects a terminal portion of the hermetic terminal and the inverter; and
a terminal receiving member disposed between the hermetic terminal and the connection terminal, the terminal receiving member including a plurality of insertion holes through which each terminal portion of the hermetic terminal is insertable and a terminal receiving surface that receives the connection terminal.

2. The electric compressor according to claim 1, wherein the terminal receiving member has a recess capable of accommodating a part of the plate portion of the hermetic terminal.

3. The electric compressor according to claim 1, wherein the connection terminal includes a press-fitting portion to be press-fitted into the terminal portion of the hermetic terminal, and a protrusion to be soldered through a through-hole of a circuit board of the inverter, and
the terminal receiving member receives the press-fitting portion and the protrusion.

4. The electric compressor according to claim 3, wherein
the protrusion is formed in a flat plate shape.

5. The electric compressor according to claim 4, wherein
a tip of the protrusion is formed in a tapered shape in which a width gradually decreases toward the tip.

6. The electric compressor according to claim 1, wherein
the terminal receiving member includes an insulating rib that ensures an insulation distance of each terminal portion of the hermetic terminal.

7. The electric compressor according to claim 6, wherein
the terminal receiving member includes an annular outer edge rib extending from an outer edge of the plate portion toward the connection terminal and having a height lower than a height of the insulating rib.

8. The electric compressor according to claim 1, wherein
the circuit board of the inverter has an opening that avoids interference with each terminal portion of the hermetic terminal and the press-fitting portion of the connection terminal.
